(19) United States
(12) Patent Application Publication
(10) Pub. No.: US 2012/0233867 A1
(43) Pub. Date: Sep. 20, 2012

(54) PENCIL SHARPENER WITH TWO BLADES

(75) Inventor: Fat Wai Bill FONG, Hong Kong (HK)

(73) Assignee: CHOON NANG ENERGY EQUIPMENT MFY., LTD., Hong Kong (HK)

(21) Appl. No.: 13/161,511

(22) Filed: Jun. 16, 2011

(30) Foreign Application Priority Data
Mar. 15, 2011 (CN) 201120069248.5
May 19, 2011 (CN) 201120160211.3

(51) Int. Cl. B43L 23/08

(52) U.S. Cl. 30/451

(57) ABSTRACT

A pencil sharpener having a support and a main blade adapted to dispose and secure onto the support is disclosed which comprises an auxiliary blade adapted to dispose onto the support and secure thereonto by a screw and a corresponding nut. The auxiliary blade is further adapted to dispose on one side of the support opposite to the side where the main blade is disposed.

### CROSS-REFERENCE TO RELATED APPLICATION

This application claims benefit under 35 U.S.C. §119 of Chinese Patent Applications having Serial No. 201120069248.5 filed Mar. 15, 2011, and having Serial No. 201120160211.3 filed May 19, 2011 which is hereby incorporated by reference herein in its entirety.

### FIELD OF INVENTION

This invention relates to a pencil sharpener, and in particular a pencil sharpener with two blades.

### BACKGROUND OF INVENTION

In conventional pencil/crayon sharpeners, one blade is equipped and so only that piece of blade is used on sharpening pencils/crayons. Practically, this has created a number of problems such as low life span of pencil sharpener, rough sharpened surfaces on the pencils/crayons, and other lack of quality issues such as the ease of the lead of the pencils/crayons to become deviated or even broken. When such problems arise, users can only throw away the pencil sharpeners and this would greatly affect the economic benefits and may even cause environmental problems.

### SUMMARY OF INVENTION

In the light of the foregoing background, it is an object of the present invention to provide an alternate pencil sharpener.

Accordingly, the present invention, in one aspect, is a pencil sharpener having a support and a main blade adapted to dispose and secure onto the support, wherein the pencil sharpener comprises an auxiliary blade adapted to dispose and secure onto the support by a screw and a corresponding nut. The auxiliary blade is further adapted to dispose on one side of the support opposite to the side where the main blade is disposed.

In an exemplary embodiment of the present invention, the main blade and the auxiliary blade are disposed on the support with an angle in the range of 120 to 240 degrees disposed therebetween, the angle being relative to the axis of the support. In one exemplary embodiment, the angle disposed between the main blade and the auxiliary blade is 180 degrees relative to the axis of the support.

In another exemplary embodiment, the main blade is secured onto the support by a pair of screws with corresponding nuts.

In yet another exemplary embodiment, the pencil sharpener further comprises a blocking member and a shaft in which the main blade is a hobbing cutter adapted to dispose and secure onto a hobbing cutter support by the blocking member and the shaft; the auxiliary blade is a blade and adapted to dispose on one side of the hobbing cutter support opposite to the side where the hobbing cutter is disposed. In one exemplary embodiment, the hobbing cutter and the blade are disposed on the hobbing cutter support with an angle in the range of 120 to 270 degrees disposed therebetween, the angle being relative to the axis of the hobbing cutter support.

There are many advantages to the present invention. For example, due to the dual blade configuration, the pencil sharpener of this invention can have a longer life span than the conventional one with only one blade. This will increase the cost-effectiveness from both economic and social perspectives.

Another advantage of the present invention is that leads of pencils will not be easily broken and the tips of the leads will not become easily deviated during sharpening. The cutting surface of pencils/crayons will also look smooth after sharpening. As a result, the pencils/crayons will become more durable.

### BRIEF DESCRIPTION OF FIGURES

FIG. 1 is an exploded view of the pencil sharpener according to one embodiment of the present invention.

FIG. 2 is a top view of the pencil sharpener according to the same embodiment of the present invention.

FIG. 3 is a bottom view of the pencil sharpener according to the same embodiment of the present invention.

FIG. 4 is an exploded view of the pencil sharpener according to one embodiment of the present invention showing different parts of the pencil sharpener.

FIG. 5 is a side view of the pencil sharpener according to the same embodiment of the present invention.

FIG. 6 is a bottom view of the pencil sharpener according to the same embodiment of the present invention.

FIG. 7 is an exploded view of the pencil sharpener according to one embodiment of the present invention showing different parts of the pencil sharpener.

FIG. 8 is a side view of the pencil sharpener according to the same embodiment of the present invention.

FIG. 9 is a top view of the pencil sharpener according to the same embodiment of the present invention.

FIG. 10 is a bottom view of the pencil sharpener according to the same embodiment of the present invention.

### DETAILED DESCRIPTION OF THE PREFERRED EMBODIMENTS

As used herein and in the claims, “comprising” means including the following elements but not excluding others.

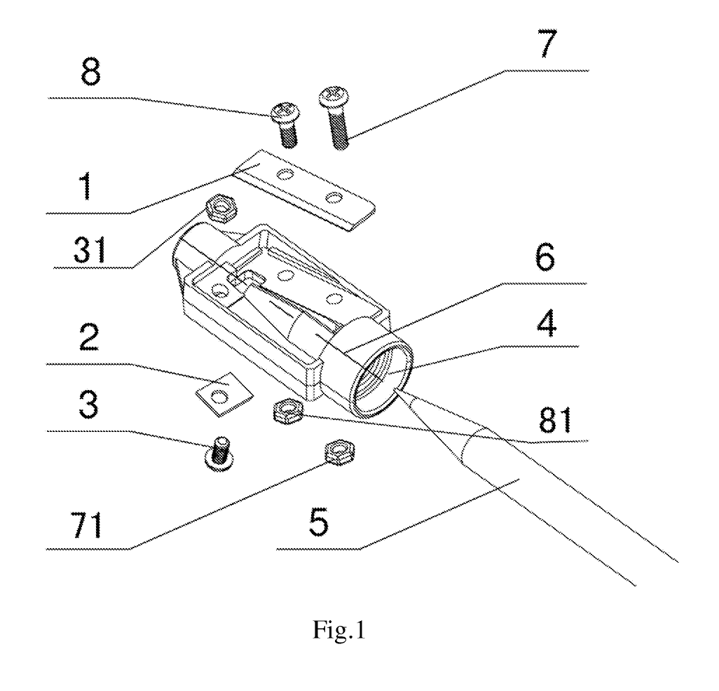

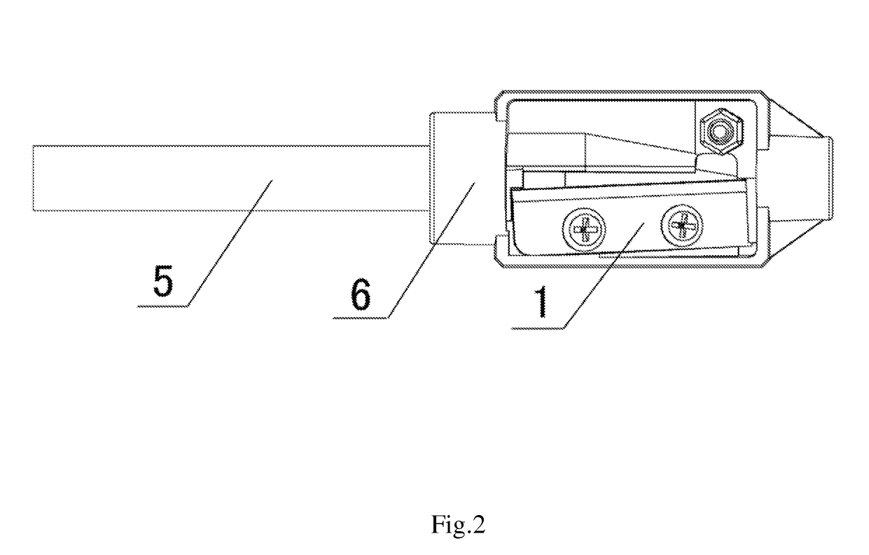

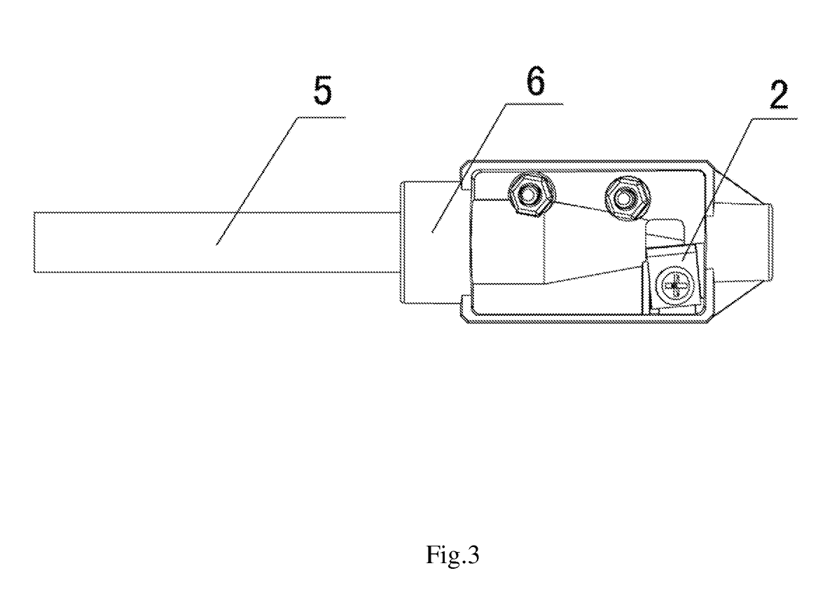

Referring now to FIGS. 1-3, the first embodiment of the present invention is a pencil sharpener comprising a support 6, a main blade 1, and an auxiliary blade 2. The main blade 1 is disposed and secured onto the support 6 by a screw 7 with the corresponding nut 71 and a screw 8 with the corresponding nut 81. The auxiliary blade 2 is disposed and secured onto the support 6 by a screw 3 with the corresponding nut 31. A hole 4 is disposed on the support 6 through which a pencil 5 can be inserted into the pencil sharpener for sharpening. In one embodiment, the auxiliary blade 2 is disposed on a side of the support 6 opposite to where the main blade 1 is disposed. The main blade 1 and the auxiliary blade 2 are secured onto the support 6 in a configuration that the angle between the disposed main blade 1 and the disposed auxiliary blade 2 is in the range of 120 to 240 degrees relative to the axis of the support 6. In another embodiment, the angle is 180 degrees relative to the axis of the support 6.

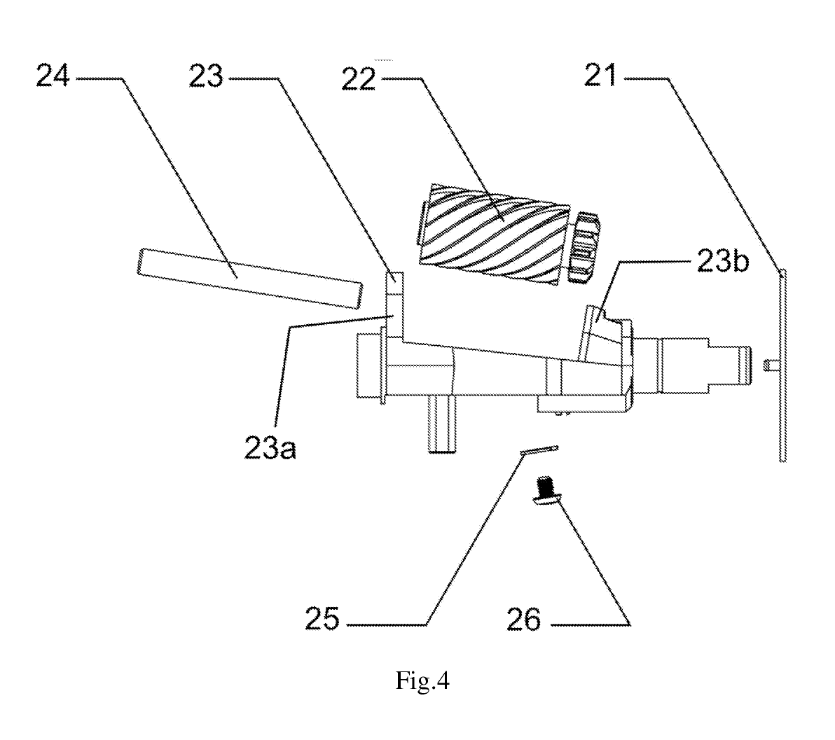

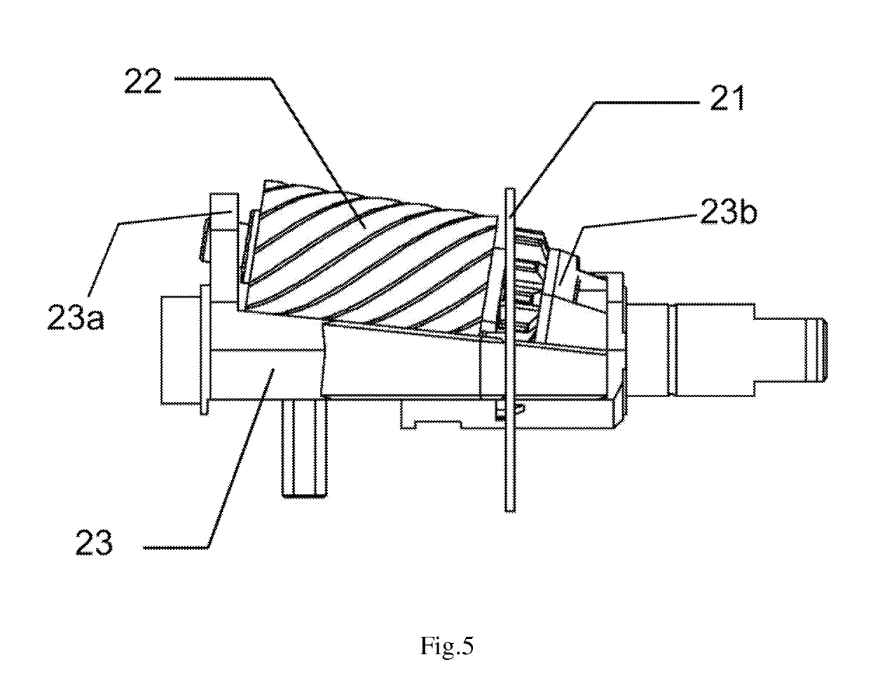

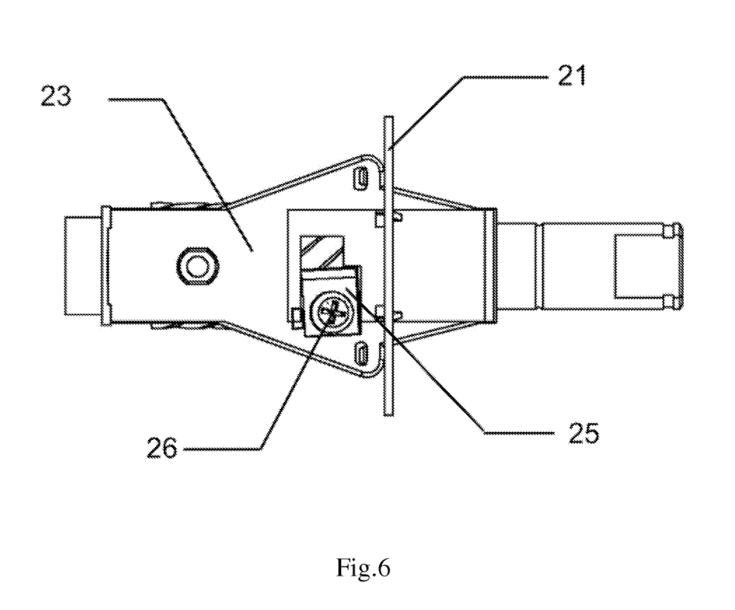

The second embodiment of the present invention is described in FIGS. 4-6 in which the pencil sharpener as shown comprises a blocking member 21, a hobbing cutter 22, a hobbing cutter support 23, a shaft 24, and a blade 25. The hobbing cutter 22 is disposed and secured onto the hobbing cutter support 23 by the blocking member 21 and the shaft 24. In one embodiment, the shaft 24 is adapted to pass from a first end 23a of the hobbing cutter support 23 through the cylindrical space at the core of the hobbing cutter 22 to a second end 23b of the hobbing cutter support 23 so that the hobbing cutter 22 is secured onto the hobbing cutter support 23. The blade 25 is disposed and secured onto the hobbing cutter support 23 by a screw 26. In one exemplary embodiment, the blade 25 is disposed on a side of the hobbing cutter support 23 opposite to where the hobbing cutter 22 is disposed. The hobbing cutter 22 and the blade 25 are secured on the hobbing cutter support 23 in a configuration that the angle between the disposed hobbing cutter 22 and the disposed blade 25 is in the range of 120 to 270 degrees relative to the axis of the hobbing cutter support 23.

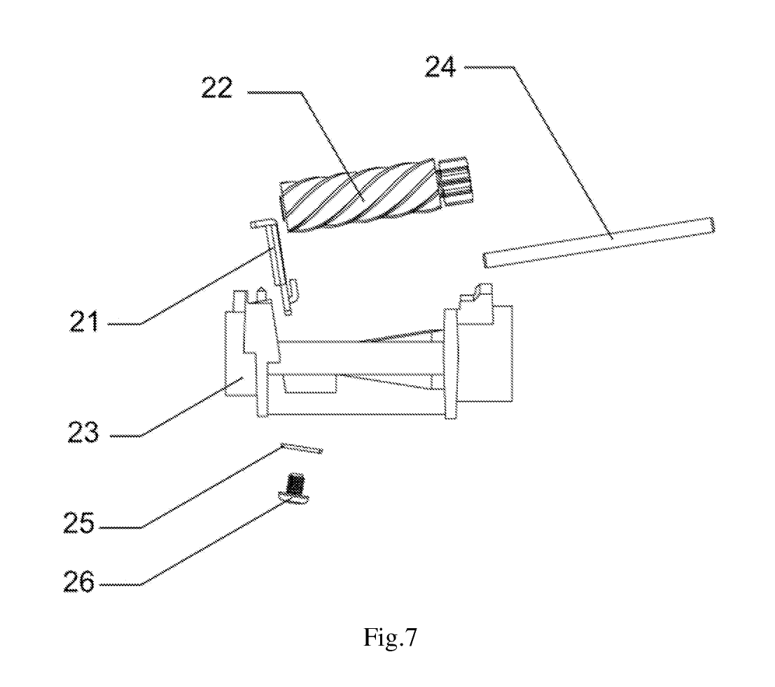

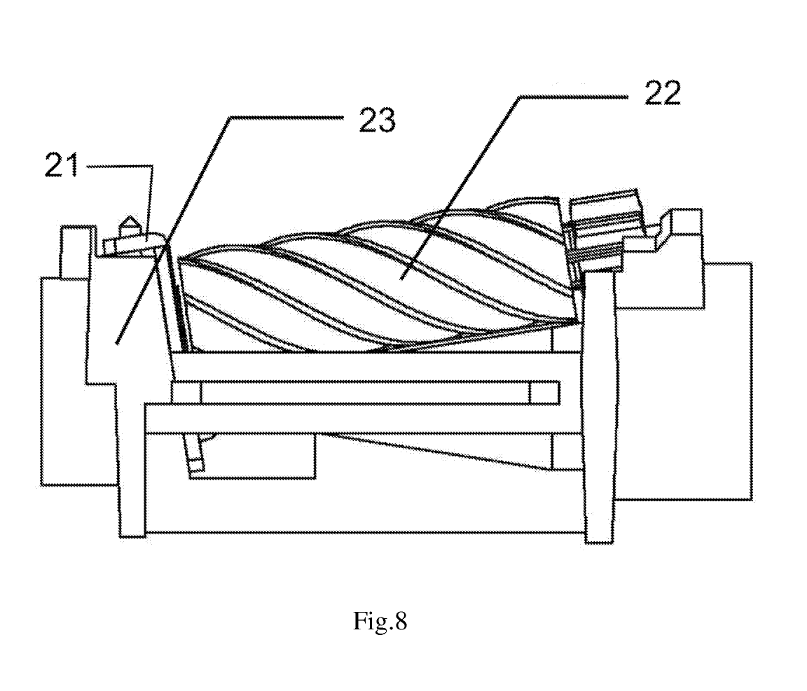

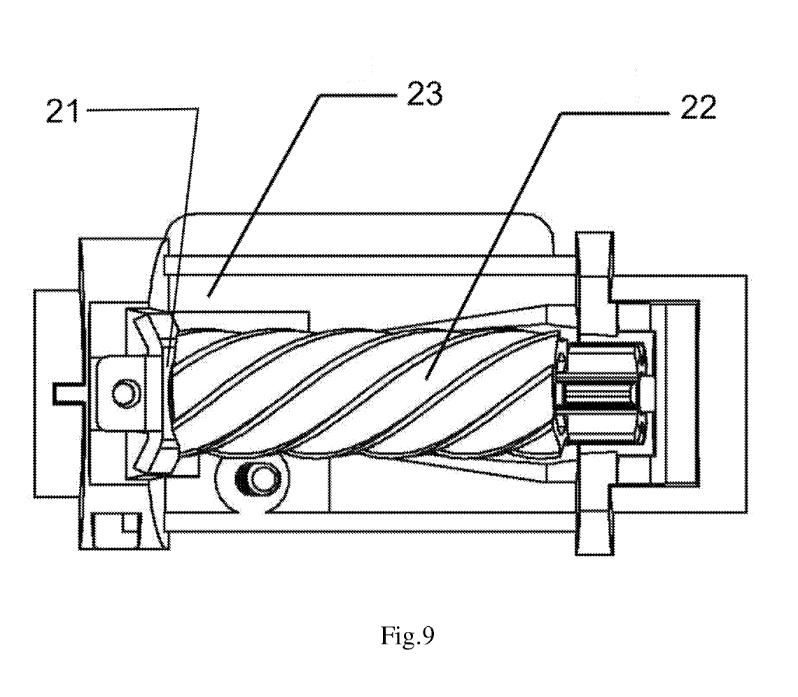

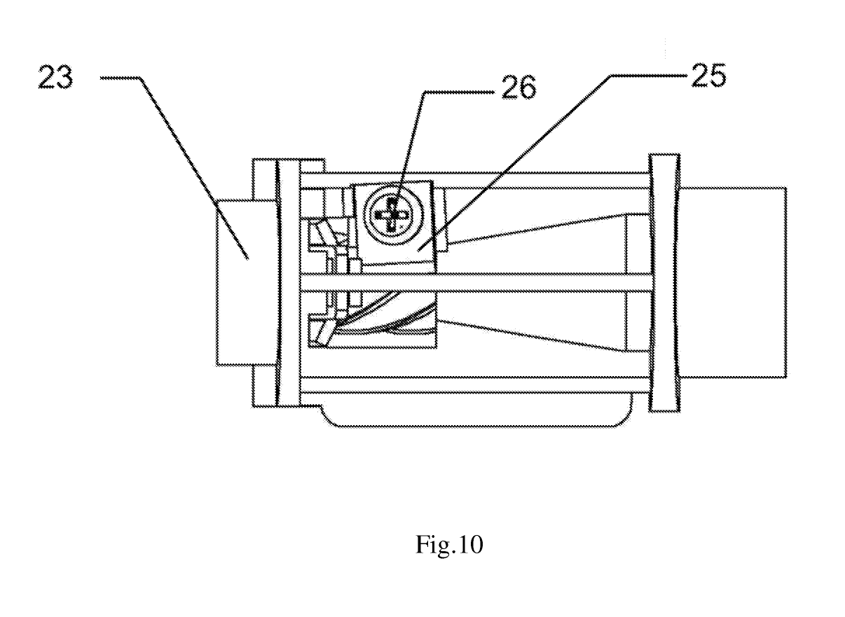

Referring now to FIGS. 7-10, a third embodiment of the present invention is illustrated in which the hobbing cutter 22 and the blade 25 of the pencil sharpener are of a smaller size than those of the pencil sharpener in the second embodiment. As such, the structures of some of the parts such as the blocking member 21 and the shaft 24 of the pencil sharpener in the third embodiment are somewhat different from those of the pencil sharpener in the second embodiment. For example, in one embodiment, the shaft 24 is adapted to pass through the cylindrical space at the core of the hobbing cutter 22 and a hole on the blocking member 21 for connecting the hobbing cutter 22 and the blocking member 21 onto the hobbing cutter support 23. As such the hobbing cutter 22 is secured onto the hobbing cutter support 23 by both the blocking member 21 and the shaft 24. In any event, the basic structure of the pencil sharpeners in these two embodiments and the working principles thereof are similar.

In the two embodiments respectively shown in FIGS. 4-6 and FIGS. 7-10, other parts of a conventional pencil sharpener equipped with a hobbing cutter 22, such as the base and the driving member to drive and direct the movement of the hobbing cutter 22 by manual, mechanical, or electrical means, are omitted for ease of illustration of this invention. It is clear to one skilled in the art that the aforesaid parts, among others, may be included in practice to result in a fully functional pencil sharpener.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

What is claimed is:

1. A pencil sharpener having a support (6) and a main blade (1) adapted to dispose and secure onto said support (6), wherein said pencil sharpener comprises an auxiliary blade (2) adapted to dispose onto said support (6) and secure thereonto by a screw (3) and a corresponding nut (31); said auxiliary blade (2) is further adapted to dispose on one side of said support (6) opposite to the side where said main blade (1) is disposed.

2. The pencil sharpener according to claim 1 wherein said main blade (1) and said auxiliary blade (2) are disposed on said support (6) with an angle in the ranges 120 to 240 degrees disposed therebetween, said angle being relative to the axis of said support (6).

3. The pencil sharpener according to claim 1 wherein said main blade (1) is secured onto said support by a pair of screws (7, 8) with corresponding nuts (71, 81).

4. The pencil sharpener according to claim 1 further comprising a blocking member (21) and a shaft (24) wherein said main blade (1) is a hobbing cutter (22) adapted to dispose and secure onto a hobbing cutter support (23) by said blocking member (21) and said shaft (24); said auxiliary blade (2) is a blade (25) and adapted to dispose on one side of said hobbing cutter support (23) opposite to the side where said hobbing cutter (22) is disposed.

5. The pencil sharpener according to claim 4 wherein said hobbing cutter (22) and said blade (25) are disposed on said hobbing cutter support (23) with an angle in the range of 120 to 270 degrees disposed therebetween, said angle being relative to the axis of said hobbing cutter support (23).
